(19) United States
(12) Patent Application Publication
(10) Pub. No.: US 2025/0391892 A1
(43) Pub. Date: Dec. 25, 2025

(54) FUEL CELL SYSTEM, RECIRCULATION ASSEMBLY FOR A FUEL CELL SYSTEM, AND METHOD FOR COOLING A DRIVE DEVICE OF A RECIRCULATION FAN IN A FUEL CELL SYSTEM

(71) Applicant: Robert Bosch GmbH, Stuttgart (DE)

(72) Inventors: Timo Bosch, Renningen (DE); Tobias Falkenau, Esslingen (DE)

(21) Appl. No.: 18/578,417

(22) PCT Filed: Jun. 27, 2022
(86) PCT No.: PCT/EP2022/067525

§ 371 Date: Jan. 11, 2024

(30) Foreign Application Priority Data
Jul. 16, 2021 (DE) 10 2021 207 630.0

(51) Int. Cl. H01M 8/04119; H01M 8/04014

(52) U.S. Cl. CPC H01M 8/04164; H01M 8/04014; H01M 8/04179

(57) ABSTRACT

The invention relates to a recirculation assembly for a fuel cell system, comprising a water separator, which can be connected to a fuel outlet of a fuel cell assembly, for at least partly separating liquid water from an exhaust gas flow coming from the fuel outlet and comprising a recirculation fan with a conveyor device, which has a fan inlet connected to the water separator and a fan outlet that can be connected to a fuel inlet of the fuel cell assembly and which is designed to convey a gas flow, and a drive device for driving the conveyor device, comprising a heat sink which is thermally coupled to the water separator in order to cool the drive device.

### BACKGROUND

The present invention relates to a fuel cell system, a recirculation assembly for a fuel cell system, and a method for cooling a drive device of a recirculation fan in a fuel cell system.

Fuel cells are being increasingly used as energy converters, among other things in vehicles, in order to directly convert the chemical energy contained in a fuel, e.g., hydrogen together with oxygen, into electrical energy. Fuel cells typically comprise an anode, a cathode, and an electrolytic membrane located between the anode and the cathode. Oxidation of the fuel occurs at the anode, and a reduction of oxygen occurs at the cathode. Water is produced on the cathode side.

Typically, the anode of fuel cells is continuously supplied with gaseous fuel in excess, that is, more fuel than would be stoichiometrically necessary for a given supply of oxygen to the cathode. The excess fuel or anode output is usually recirculated or re-supplied to the anode. This is usually done by means of a recirculation fan, which conveys the anode output from an outlet of the anode back to the inlet of the anode.

The recirculation fan is typically operated by means of an electric motor. To improve the energy efficiency and the service life of the recirculation fan, cooling the same is advantageous. US 2009/0014149 A1 discloses a fuel cell system having a recirculation fan, wherein the recirculation fan is cooled by hydrogen from a hydrogen tank.

As the product water formed on the cathode side of a fuel cell as a result of the chemical reaction may reach the anode side, water may be included in the excess fuel, which would be re-fed to the anode when the excess fuel is recirculated. In order to avoid excessive accumulation of water on the anode, water separation is usually carried out during the recirculation of the excess fuel. For example, JP 2005 116354 A describes a fuel cell system having a water separator in a recirculation path.

### SUMMARY

According to the disclosure, a recirculation assembly for a fuel cell system, a fuel cell system and a method for cooling a drive device of a recirculation fan in a fuel cell system are provided.

According to a first aspect of the invention, a recirculation assembly for a fuel cell system comprising a water separator, which can be connected to a fuel outlet of a fuel cell assembly, for at least partly separating liquid water from an exhaust gas flow coming from the fuel outlet and comprising a recirculation fan with a conveyor device, which has a fan inlet connected to the water separator and a fan outlet that can be connected to a fuel inlet of the fuel cell assembly and is designed to convey a gas flow, and a drive device for driving the conveyor device, comprising a heat sink which is thermally coupled to the water separator in order to cool the drive device.

According to a second aspect of the invention, a fuel cell system is provided, which comprises: a fuel cell assembly having at least one fuel cell, a fuel inlet and a fuel outlet, a supply line connected to the fuel inlet for supplying gaseous fuel and a recirculation assembly according to the first aspect of the invention, wherein the water separator is connected to the fuel outlet, and wherein the fan output of the conveyor device of the recirculation fan is connected to the supply line.

According to a third aspect of the invention, a method for cooling a drive device of a recirculation fan in a fuel cell system is provided. For example, the method according to this aspect of the invention may be performed in the fuel cell system according to the second aspect of the invention and/or using the recirculation assembly according to the first aspect of the invention. The method according to the invention comprises at least partly separating liquid water from the anode-side exhaust gas flow of a fuel cell assembly of the fuel cell system in a water separator and supplying the anode-side exhaust gas flow and/or the separated liquid water from the water separator to the drive device as cooling medium.

One idea underlying the invention is to use in a fuel cell system the mass flow coming from the anode containing gaseous fuel and water to cool a drive device of a recirculation fan. The drive device, which may comprise an electric motor and optionally control electronics for controlling the electric motor, for example, is thermally coupled to a water separator via a heat sink, in which water is discharged as completely as possible from the mass flow coming from the anode. The heat sink can be configured, for example, by a housing of the drive device, wherein the electric motor and optionally the control electronics can be accommodated in the housing, for example.

An advantage of the invention is in the use of the cooling potential of the mass flow coming from the anode, which is also hereinafter referred to as anode output, exhaust flow or recirculation gas flow. Thus, a separate coolant supply to the drive device of the recirculation fan is no longer necessarily required. This advantageously reduces the complexity of the fuel cell system. In addition, the energy efficiency of the system is improved.

Advantageous embodiments and further developments follow from the additional dependent claims and from the description with reference to the figures of the drawing.

According to some embodiments, it may be provided that the exhaust gas flow and/or separated liquid water flows around the heat sink. The thermal coupling to the water separator can thus be realized, for example, by having separated water and/or recirculation gas flow around the heat sink, in particular the housing of the drive device, on its outer surface. This simplifies the design of the heat sink.

According to some embodiments, it may be provided that the heat sink extends into a separation section of the water separator that is configured to separate the liquid water from the exhaust gas flow. The separation path is generally defined by an internal volume of the water separator through which the anode exhaust gas flows and in which the separated water collects. Thus, the heat sink may be thermally coupled to the water separator by being at least partly arranged in the internal volume of the water separator. This further simplifies the design of the recirculation assembly. Another advantage of circulating the heat sink with recirculation gas is that heat is supplied by the recirculation gas flow, which contributes to evaporation of liquid particles in the recirculation gas flow. Thus, the introduction of liquid particles into the anode via the recirculation gas flow may be advantageously reduced.

According to some embodiments, it may be provided that the heat sink comprises a coolant channel connected to the water separator for passing the exhaust gas flow and/or separated liquid water. Accordingly, it may be provided that cooling medium from the water separator flows through the cross-section of the heat sink. An even better heat transfer between the drive device and the cooling medium can thus be achieved.

According to some embodiments, the coolant channel may be provided to connect a recirculation outlet of the water separator through which the exhaust gas flow can be discharged from the water separator to the fan inlet of the conveyor device. Thus, the exhaust gas flow to be recirculated is first directed through the coolant channel before it is supplied through the fan inlet of the conveyor. This provides the advantage that evaporation of liquid particles is conveyed in the recirculation gas flow and the proportion of liquid particles in the gas flow supplied to the conveyor device is advantageously reduced. This helps to reduce the load on the conveyor device.

According to some embodiments, it may be provided that the fan inlet of the conveyor device is connected to a recirculation outlet of the water separator through which the exhaust gas flow is discharged from the water separator, wherein the coolant channel is connected to the fan outlet of the conveyor device. Thus, the exhaust gas flow to be recirculated is first compressed by the conveyor device and, before flowing to the fuel inlet of the fuel cell, directed through the coolant channel. The conveyor device can thus be supplied with as cool a gas flow as possible, which has a favorable effect on the efficiency of the conveyor device.

According to some embodiments, it may be provided that the coolant channel is connected to a water outlet through which liquid water discharged from the exhaust gas flow can be discharged and/or to a purge outlet through which purge gas can be discharged. The water separated in the water separator from the exhaust gas flow may be discharged through the water outlet, particularly cyclically or at predetermined intervals. Thus, the cooling potential of the anode output can be easily utilized without this causing a flow loss in the recirculation gas. Optionally, the coolant channel may at least in regions be provided with an adsorptive lining, such as a lining made of zeolite, a sintered metal, or other material with a large internal surface. Alternatively, it would be conceivable that the lining is realized by the cooling center channel having a high surface roughness. This facilitates quasi-continuous heat dissipation during cyclic filling of the coolant channel with water. The anode side of the fuel cell assembly may optionally be purged with fuel at predetermined intervals to purge nitrogen, which may accumulate at the anode. The purged gas may also be used for cooling.

According to some embodiments, supplying the anode-side exhaust gas flow and/or the separated liquid water as a cooling medium to the drive device may comprise flowing around an outer surface of a heat sink of the drive device or flowing through a coolant channel of the heat sink.

### BRIEF DESCRIPTION OF THE DRAWINGS

The invention will be explained hereinafter with reference to the figures of the drawings. The drawings show:

FIG. 1 a schematic view of a hydraulic diagram of a fuel cell system according to an exemplary embodiment of the invention;

FIG. 2 a schematic block diagram of a recirculation assembly according to an exemplary embodiment of the invention;

FIG. 3 a schematic block diagram of a recirculation assembly according to a further exemplary embodiment of the invention;

FIG. 4 a schematic block diagram of a recirculation assembly according to a further exemplary embodiment of the invention;

FIG. 5 a schematic block diagram of a recirculation assembly according to a further exemplary embodiment of the invention; and

FIG. 6 a flow diagram of a method for cooling a drive device of a recirculation fan in a fuel cell system according to an exemplary embodiment of the invention.

### DETAILED DESCRIPTION

Unless otherwise stated, the same reference numbers refer to like or functionally identical components shown in the figures.

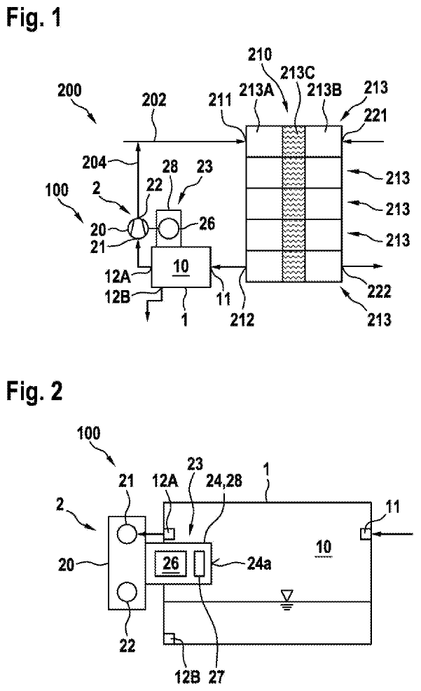

FIG. 1 schematically shows a fuel cell system 200. As shown schematically in FIG. 1, the fuel cell system 200 comprises a supply line 202, a fuel cell assembly 210, and a recirculation assembly 100.

The fuel cell assembly 210 may have a plurality of fuel cells 213 arranged in a stack, as exemplified in FIG. 1. However, it is also generally conceivable that only one fuel cell 213 is provided. As shown schematically in FIG. 1, each fuel cell 213 may comprise an anode 213A, a cathode 213B, and an electrolyte 213C arranged between them, e.g., in the form of an electrolyte membrane.

The fuel cell assembly 210 further comprises a fuel inlet 211 via which gaseous fuel, e.g., hydrogen or natural gas, can be supplied to anode 213A and a fuel outlet 212 via which unused or unreacted fuel can be discharged from anode 213A. Unconsumed fuel discharged at the fuel outlet 212 may also be referred to as excess fuel or anode exhaust gas.

Furthermore, the fuel cell assembly 210 may comprise an oxygen inlet 221 via which gaseous oxygen, either as pure oxygen or as oxygen contained in ambient air, can be supplied to the cathode 213B and a product outlet 222 via which unused or unreacted oxygen as well as chemical reaction products, in particular water, can be discharged from the cathode 213B. In the reduction reaction taking place at the cathode, water is produced. This is largely discharged via the product outlet 222. However, some of this water may pass through the electrolyte 213C to the anode 213A and be carried away as part of the excess fuel or anode exhaust gas.

The supply line 202 serves to supply the fuel into the fuel inlet 211. Accordingly, the supply line 202 is connected to the fuel inlet 211. For example, an inlet of supply line 202 may be connected to a fuel reservoir or tank (not shown).

Recirculation assembly 100 is shown only schematically in FIG. 1 and is adapted to recirculate excess fuel from fuel outlet 212 of fuel cell assembly 210 to fuel inlet 211. As shown schematically in FIG. 1, the recirculation assembly 100 comprises a water separator 1 and a recirculation fan 2.

The water separator 1 is shown in FIG. 1 as a block only, and comprises an inlet 11 connected to the fuel outlet 212 of the fuel cell assembly 210, a separation section 10, a recirculation outlet 12A and a water outlet 12B. The separation section 10 is configured to separate liquid water contained in the anode exhaust gas flow from it. This may be done, for example, using baffles, adsorptive materials, or in a similar manner. Generally, the separation section 10 defines an interior of the water separator 1 for passing through the anode exhaust gas and for receiving liquid water. The anode exhaust gas can be supplied to the water separator 1 via the inlet 11 and can be removed from it by the recirculation outlet 12A. The water that accumulates in the interior or the separation section may be discharged from the anode exhaust gas via water outlet 12B.

The recirculation fan 2 is also shown only schematically in FIG. 1 and comprises a conveyor device 20 and a drive device 23 for driving the conveyor device 20. As shown schematically in FIG. 1, conveyor 20 has a fan inlet 21 connected to outlet 12 of water separator 1 and a fan outlet 22 connected to anode inlet 211 of fuel cell assembly 210. To convey a mass gas flow from the fan inlet 21 to the fan outlet 22, the conveyor device 20 may comprise, for example, a paddle wheel (not shown), which can be rotated by the drive device 23. The conveyor device 20 is generally configured to convey a gas flow.

The drive device 22 may have, for example, an electric motor 26 to drive conveyor device 20, as shown schematically in FIG. 1. This may be accommodated in, for example, a housing 28. The drive device 22 comprises a heat sink 24 (FIGS. 2 to 4), which may be formed, for example, by the housing 28. Alternatively, the heat sink 24 may be connected to the housing 28 or otherwise thermally coupled to the motor 26. The heat sink 24 is also thermally coupled to the water separator 1 to cool the drive device 23 by the anode exhaust gas and/or the liquid water separated from it.

FIG. 2 schematically illustrates a recirculation assembly 100 as described in connection with FIG. 1. As shown schematically in FIG. 2, for the thermal coupling of the heat sink 24 of the drive device 23 to the water separator 1, it can be provided that the heat sink 24 projects into the separation section 10 or the interior of the water separator 1. It is schematically and purely exemplary shown in FIG. 2 that the heat sink 24 is arranged in the interior of the water separator 1 such that the anode exhaust gas flows around its outer surface 24a before it is supplied to the fan inlet 21 by the recirculation outlet 12A. The heat sink 24 could also be arranged in the interior or the separation section 10 of the water separator 1 such that it projects into the separated liquid water at least temporarily or depending on the fill level of the water separator 1. Alternatively, it would also be conceivable that the exhaust flow and/or the separated liquid water would flow around the heat sink 24 outside of the separation section 10. In general, the heat sink 24 may be configured to be flowed around by the exhaust gas flow and/or by separated liquid water.

It is shown purely by way of example in FIG. 2 that the housing 28 in which the electric motor 26 is arranged forms the heat sink 24. As shown purely by way of example in FIG. 2, optionally a power electronic circuit 27 for controlling the electric motor 26 may also be arranged in the housing 28. The fan output 22 can be connected to the fuel inlet 211 of the fuel cell assembly 210 at the recirculation assembly 100 shown in FIG. 2, for example, via a recirculation line 204 connected to the supply line 202 (FIG. 1).

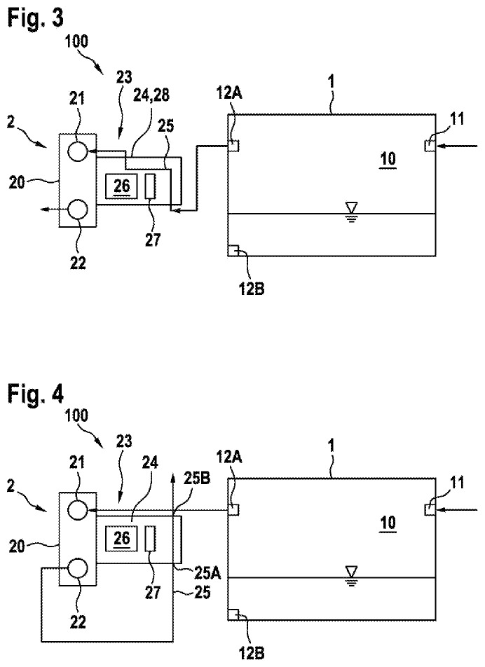

FIG. 3 schematically illustrates another exemplary recirculation assembly 100. The recirculation assembly 100 shown in FIG. 3 differs from the recirculation assembly 100 shown in FIG. 2, in particular in that the flow does not pass around the outer surface 24a of the heat sink 24 or the housing 28, but the heat sink 24 comprises a coolant channel 25 connected to the water separator 1 for passing the exhaust gas flow. The coolant channel 25 has an input 25A and an output 25B and may extend between the input 25A and the output 25B in a predetermined manner in the heat sink 24, for example, integrated into its cross-section or connected to its surface.

As exemplarily shown in FIG. 3, coolant channel 25 may be connected to recirculation outlet 12A of water separator 1 and fan inlet 21 of conveyor device 20. That is, the coolant channel 25 may connect the recirculation outlet 12A of the water separator 1, through which the exhaust gas flow exits the water separator 1, to the fan inlet 21. Thus, in this case, heat exchange takes place between the drive device 23 and the exhaust gas flow coming from the water separator 1 before the exhaust gas or recirculation gas is compressed by the conveyor device 20. The fan output 22 can be connected to the fuel inlet 211 of the fuel cell assembly 210 at the recirculation assembly 100 shown in FIG. 3, for example, via the recirculation line 204 connected to the supply line 202 (FIG. 1).

It is exemplarily shown in FIG. 3 that the heat sink 24 may be arranged entirely outside of the separator section 10. The method is, however, not limited thereto. It is also conceivable, for example, that a portion of the heat sink 24 extends into the separator section 10 of the water separator 1. Thus, optionally, the heat sink 24 may additionally have exhaust gas and/or separated liquid water flowing around its outer surface 24a.

FIG. 4 exemplarily and schematically illustrates another recirculation assembly 100, which is substantially the same as the recirculation assembly 100 shown in FIG. 3. In contrast to FIG. 3, it is exemplarily shown in FIG. 4 that the fan inlet 21 of conveyor device 20 is connected directly to the recirculation outlet 12A of water separator 1, and the coolant channel 25 is connected to the fan outlet 22 of conveyor device 20. The output 25B of the coolant channel 25 in this case can be connected to the fuel input 211 of the fuel cell assembly 210, for example, via the recirculation line 204 connected to the supply line 202 (FIG. 1).

The recirculation assemblies 100 shown in FIGS. 3 and 4 comprise the heat sink 24, each having a coolant channel 25 connected to the water separator 1 for passing the exhaust gas flow.

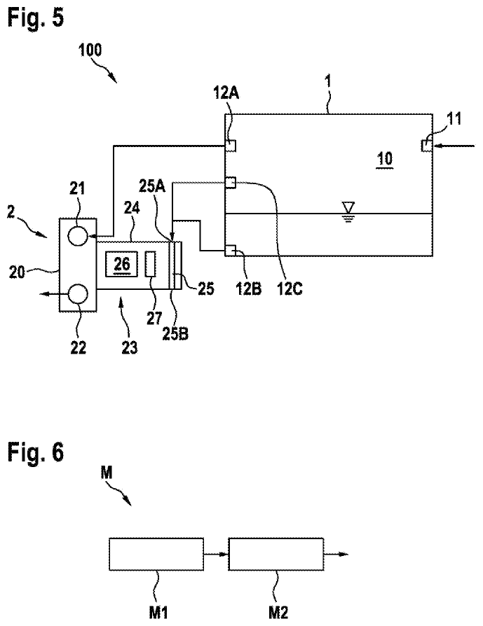

By way of example, FIG. 5 illustrates another recirculation assembly 100. This differs from the recirculation assembly 100 shown in FIG. 4 in that for the thermal coupling of the drive device 23 to the water separator 1, the input 25A of the coolant channel 25 is not connected to the fan outlet 22 but to the water outlet 12B of the water separator 1. Alternatively or additionally, the input 25A of the coolant channel 25 may be connected to an optional purge output 12C of the water separator 10, as also exemplified in FIG. 5.

For example, liquid water separated from the exhaust gas flow may be drained cyclically via water outlet 12B from the separator section 10 of the water separator 1, for example, by opening a discharge valve (not shown). The water flows through the coolant channel 25, absorbing heat from the drive device. Optionally, the coolant channel 25 may comprise an adsorptive lining (not shown) or an adsorptive cooling section (not shown) configured to adsorb water. The adsorbed water may then be desorbed again with the absorption of heat. Thus, in the case of a cyclic passage of liquid water, a quasi-continuous cooling of the drive device 23 can be facilitated. A sorbent material, such as a zeolite, sinter metal, or the like, or a correspondingly rough designed surface of the coolant channel 25 is considered to be an adsorptive lining or cooling section.

The optional purge outlet 12C of the water separator 10 is used to discharge purge gas or purged gas that is purged from the fuel cell assembly 210 through the fuel outlet 212 by a supply of fuel through the fuel inlet 211 of the fuel cell assembly 210 when the conveying device 20 is deactivated, i.e., when recirculation is deactivated. This serves in particular to purge accumulated nitrogen at the anode 213A. This purge gas, which also forms anode exhaust gas, may be discharged through the coolant channel 25 via the purge connection 12C. Thus, the coolant channel 25 may be generally provided for passing the exhaust gas flow and/or separated liquid water.

The output 25B of the coolant channel 25 can be connected to the fuel input 211 of the fuel cell assembly 210 in the recirculation assembly 100 shown in FIG. 5, for example, via the recirculation line 204 connected to the supply line 202 (FIG. 1).

FIG. 6 shows, by way of example, a method M for cooling a drive device 23 of a recirculation fan 2 in a fuel cell system 200. The method M is explained below, by way of example, with reference to the fuel cell system 200 shown in FIG. 1 and the recirculation assemblies 100 shown in FIGS. 2 to 5.

In a first step M1, liquid water is at least partially separated from anode-side exhaust gas of the fuel cell assembly 210 of the fuel cell system 200 in the water separator 1. The separated liquid water collects in the interior or the separator section 10 of the water separator 1.

In a further step M2, the anode-side exhaust gas flow and/or the liquid water separated therefrom is supplied from the water separator 1 to the drive device 23 as cooling medium. This may be done, for example, by flowing around the outer surface 24a of the heat sink 24 of the drive device 23, as explained as an example with reference to FIG. 2. Alternatively or additionally, it may be provided that exhaust gas and/or liquid water separated therefrom flows through the coolant channel 25 of the heat sink 24.

Although the present invention has been explained hereinabove with reference to exemplary embodiments, the invention is not limited thereto and can instead be modified in a variety of ways. Combinations of the exemplary embodiments hereinabove are in particular also conceivable.

1. A recirculation assembly (100) for a fuel cell system (200), comprising:
a water separator (1), which can be connected to a fuel outlet (212) of a fuel cell assembly (210), for at least partly separating liquid water from an exhaust gas flow coming from the fuel outlet (212); and
a recirculation fan (2) with a conveyor device (20), which has a fan inlet (21) connected to the water separator (1) and a fan outlet (22) that can be connected to a fuel inlet (211) of the fuel cell assembly (210) and which is designed to convey a gas flow, and a drive device (23) for driving the conveyor device (20), comprising a heat sink (24) which is thermally coupled to the water separator (1) in order to cool the drive device (23).

2. The recirculation assembly (100) according to claim 1, wherein the exhaust gas flow and/or separated liquid water is configured to flow around the heat sink (24).

3. The recirculation assembly (100) according to claim 2, wherein the heat sink (24) projects into a separation section (10) of the water separator (1) which is configured to separate the liquid water from the exhaust gas flow.

4. The recirculation assembly (100) according to claim 1, wherein the heat sink (24) comprises a coolant channel (25) connected to the water separator (1) for passing the exhaust gas flow and/or separated liquid water.

5. The recirculation assembly (100) according to claim 4, wherein the coolant channel (25) connects a recirculation outlet (12A) of the water separator (1) through which the exhaust gas flow is discharged from the water separator (1) to the fan inlet (21) of the conveyor device (20).

6. The recirculation assembly (100) according to claim 4, wherein the fan inlet (21) of the conveyor device (20) is connected to a recirculation outlet (12A) of the water separator (1), through which the exhaust gas flow is discharged from the water separator (1), and wherein the coolant channel (25) is connected to the fan outlet (22) of the conveyor device (20).

7. The recirculation assembly (100) according to claim 4, wherein the coolant channel (25) is connected to a water outlet (12B) through which liquid water separated from the exhaust gas flow can be discharged and/or to a purge outlet (12C) through which purge gas can be discharged.

8. A fuel cell system (200) comprising:
a fuel cell assembly (210) with at least one fuel cell (213), a fuel inlet (211) and a fuel outlet (212);
a supply line (202) connected to the fuel inlet (211) for supplying gaseous fuel; and
a recirculation assembly (100) according to claim 1;
wherein the water separator (1) is connected to the fuel outlet (212); and
wherein the fan output (22) of the conveyor device (20) of the recirculation fan (2) is connected to the supply line (202).

9. A method (M) for cooling a drive device (23) of a recirculation fan (2) in a fuel cell system (200), comprising:
at least partially separating (M1) liquid water from anode-side exhaust gas of a fuel cell assembly (210) of the fuel cell system (200) in the water separator (1); and
supplying (M2) the anode-side exhaust gas and/or liquid water separated from the water separator (1) to the drive device (23) as a cooling medium.

10. The method (M) according to claim 9, wherein supplying (M2) the anode-side exhaust gas flow and/or the separated liquid water as cooling medium to the drive device (23) comprises flowing around an outer surface (24a) of a heat sink (24) of the drive device (23) or flowing through a coolant channel (25) of the heat sink (24).
